(19) United States
(12) Patent Application Publication
(10) Pub. No.: US 2014/0372517 A1
(43) Pub. Date: Dec. 18, 2014

(54) Systems and Methods for a Video Sharing Social Network

(71) Applicants: Patrick Zuili, Boca Raton, FL (US); Daren Stabinski, Weston, FL (US)

(72) Inventors: Patrick Zuili, Boca Raton, FL (US); Daren Stabinski, Weston, FL (US)

(21) Appl. No.: 14/345,375

(22) PCT Filed: Aug. 29, 2012
(86) PCT No.: PCT/US2012/052924

§ 371 Date: Jun. 5, 2014

Related U.S. Application Data
(60) Provisional application No. 61/528,732, filed on Aug. 29, 2011.

(51) Int. Cl. H04L 29/06; G06Q 50/00

(52) U.S. Cl. CPC H04L 65/60; H04L 67/42; G06Q 50/01
USPC 709/203

(57) ABSTRACT

Systems and methods are provided for sharing streaming audio and video in a social network. One or more servers receive streaming video and/or audio data from one or more broadcasting clients. The one or more servers create one or more webpages controlled by the one or more broadcasting clients. The one or more webpages include streaming video and/or audio data from the one or more broadcasting clients. The one or more servers serve the one or more webpages to the one or more broadcasting clients and one or more viewing clients in a social network. In various embodiments, the one or more servers receive the streaming video and/or audio data using a real time protocol and authenticate the streaming video and/or audio data by decrypting and authenticating an encrypted token in the meta data of the real time protocol.

### CROSS-REFERENCE TO RELATED APPLICATION

This application claims the benefit of U.S. Provisional Patent Application No. 61/528,732 filed Aug. 29, 2011, which is incorporated by reference in its entirety.

### INTRODUCTION

Generally, high definition video sharing has required expensive cameras connected to dedicated high-bandwidth communication channels. Low quality video conferencing has also been available using low-cost cameras embedded in or connected to computers, tablets, or smartphones that communicate across the Internet or cellular phone networks. Currently, there is a need for systems and methods that can provide high definition video sharing using low-cost cameras connected to the Internet or cellular phone networks, as well as low bandwidth and low latency usage. There is also a need for applications that exploit the capabilities of high definition video sharing on common communication devices.

Static information, such as text or image files, was originally exchanged across electronic networks primarily in a peer to peer configuration. This information, for example, was sent from an e-mail sender and received by one or more e-mail recipients. Generally, this information was private. It was only available to the e-mail sender and the one or more e-mail recipients.

The exchange of static information across electronic networks was later expanded to a client/server configuration in the form of chat rooms and social networking sites. In this configuration, the information exchanged between a sender and one or more recipients is also available to one or more known or unknown third parties. Essentially, this information is exchanged through a server, or cloud computing system, that is available to one or more third-party clients or devices.

Dynamic information, such as streaming video and/or audio data, has also traditionally been exchanged across electronic networks in a peer to peer configuration. For example, dynamic information is generally exchanged directly between video and/or audio players executing on separate devices.

There is a need to expand the exchange of dynamic information across electronic networks to a client/server configuration. Such a configuration would allow dynamic information to be available to social networks that include one or more third-party clients or devices.

However, the high-bandwidth requirements for dynamic information impose a number of technological limitations that must be overcome in order to allow dynamic information to be available to social networks.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a schematic diagram of a system for providing a registration process for the viewphone applications, in accordance with various embodiments.

FIG. 3 is a schematic diagram of a system for providing an invitation process for the viewphone applications, in accordance with various embodiments.

FIG. 4 is a schematic diagram of a system for providing a handshake process for the viewphone applications, in accordance with various embodiments.

FIG. 5 is an exemplary flow chart illustrating a method for sellers of products to market their products on the Internet using the viewphone applications, in accordance with various embodiments.

FIG. 6 is an exemplary webpage of a first user showing the video broadcast by a first user, in accordance with various embodiments.

FIG. 7 is an exemplary webpage of a first user showing the video broadcast by the first user and a second user, in accordance with various embodiments.

FIG. 8 is an exemplary webpage of a first user showing the video broadcast by the first user, the second user, and a third user, in accordance with various embodiments.

FIG. 9 is a schematic diagram of a system for video and audio sharing across a network, in accordance with various embodiments.

FIG. 10 is a schematic diagram of a system for video and audio sharing across a network that uses direct server broadcasting, in accordance with various embodiments.

FIG. 11 is a schematic diagram of a system for video and audio sharing across a network that allows full cloud gaming, in accordance with various embodiments.

FIG. 12 is a flowchart showing a method for sharing streaming audio and video data in a social network, in accordance with various embodiments.

FIG. 13 is a schematic diagram of a system of distinct software modules that performs a method for sharing streaming audio and video data in a social network, in accordance with various embodiments.

Before one or more embodiments of the invention are described in detail, one skilled in the art will appreciate that the invention is not limited in its application to the details of construction, the arrangements of components, and the arrangement of steps set forth in the following detailed description. The invention is capable of other embodiments and of being practiced or being carried out in various ways. Also, it is to be understood that the phraseology and terminology used herein is for the purpose of description and should not be regarded as limiting.

### DESCRIPTION OF VARIOUS EMBODIMENTS

### Computer-Implemented System

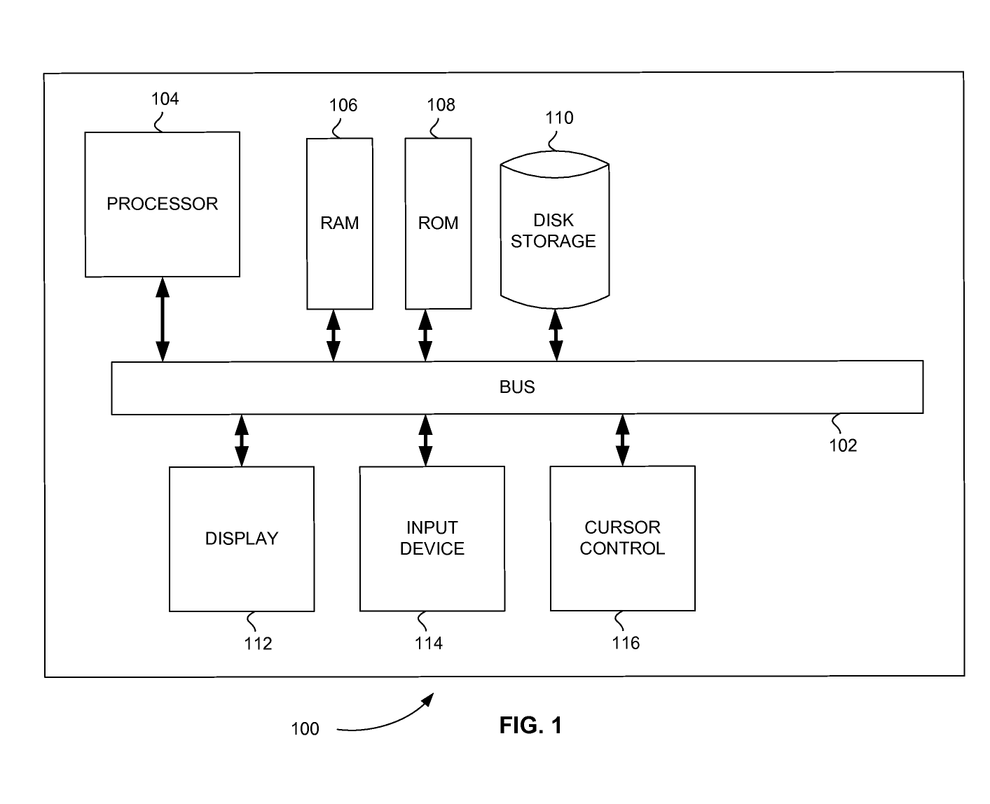

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes wireless, cellular networks, coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods for Video Sharing

As described above, there is a need for systems and methods that can provide high definition video sharing using low-cost cameras connected to the Internet or cellular phone networks. There is also a need for applications that exploit the capabilities of high definition video sharing on common communication devices.

In various embodiments, high definition video sharing using low-cost cameras, common communication devices, and available networks provides new opportunities for social networking and business applications. For example, a person's online status is not only known, it is seen. A camera or screencasting from a person's cellphone or smartphone constantly streams high quality or high definition video of the person or his or her location to let others know his or her status. Screencasting is a process where the screen is captured and streamed to a network.

Such a capability is extremely valuable for business applications as well. For example, a lawyer can stream live video of himself on his webpage. A client can then simply consult the lawyer's webpage to determine if he is in the office and available. Similarly, live streaming video can be embedded in a calendar application. In this way, participants in a conference can check the availability of others when scheduling a last minute conference by clicking on a link sent by email that opens a video and/or audio player directly on the hypertext transfer protocol (HTTP) email.

Essentially, high definition video sharing from camera or screencasting or video conferencing using low-cost cameras, common communication devices, and available networks makes the entire world a virtual office. Instead of walking down a hall and peering into an office, a co-workers status is determined by simply viewing their video stream.

Embodiments of systems and methods for high quality video sharing or video conferencing using low-cost cameras, common communication devices, and available networks provide a viewphone application (also referred to as viewphone, application, or mobile application) that may be installed on a personal computer and/or mobile device. Each registered user may be catalogued in a central server database and be identified by various information (e.g., name, telephone number, address, email address, cookies, cross-domain cookies, etc.).

Two users of the viewphone application may establish a peer-to-peer connection using a transmission control protocol (TCP) or user datagram protocol (UDP) Internet protocol (IP) for an audio and/or video conference. The viewphone application may allow any registered user or identified user using cookies to connect to any other registered user or identified user using cookies through their telephone number, for example. One skilled in the art will appreciate that other means of peer-to-peer connection may equally be used.

A first exemplary process relates to communication between two registered users. A registered user can be described also as an identified user. If a registered user (e.g., user 1) attempts to connect to another person/device that the server also identifies as a registered user (e.g., user 2), the connection between the two registered users is made. User 2 is alerted on his computer and/or mobile device that user 1 is attempting to contact him, and user 2 decides whether to accept or ignore the call. A registered user may optionally upload his or her game or the title/or serial number that identify a game to a server in order for two registered users to play a game stored on the server. One skilled in the art will appreciate that other methods of identifying a game can equality be used.

The viewphone application also has the capability to measure the available bandwidth of each user. If either user has insufficient bandwidth to make a clear audio and video connection with the other user, the audio seamlessly switches to the user's mobile telephone line or landline. Optionally, the viewphone application may also scan available WiFi phones located around the computer and use the WiFi phones' ID as user identifiers. Additionally, the viewphone application may also provide information on how many WiFi enabled phones are located at a user location and if the WiFi phone(s) are currently connected to the network. This information is used to recover cross-domain cookies stored in the WiFi phone(s). This process may allow the entire available bandwidth to be used for the video connection (through TCP or UDP IP). The connection to the user's telephone for the audio may be made through direct connection or Bluetooth, for example.

A second exemplary process relates to communication between one registered user and one non-registered user. If a registered user (e.g., user 3) attempts to connect to another person/device that the server does not identify as a registered user (e.g., user 4), the viewphone application alerts user 3 that user 4 is not a registered user of the viewphone application. The viewphone application asks user 3 if he wants to invite user 4 to join the viewphone application. If user 3 agrees, the central server sends an invitation to user 4 via short message service (SMS) text message and/or email to download the viewphone application. If user 4 agrees to download the viewphone application, he goes through the registration process at which time he provides the central server database with his personal information (e.g., name, telephone number, address, email address, etc.). Once the registration is completed, the viewphone application makes the audio and/or video connection between user 3 and user 4 as is described in the first exemplary process described above.

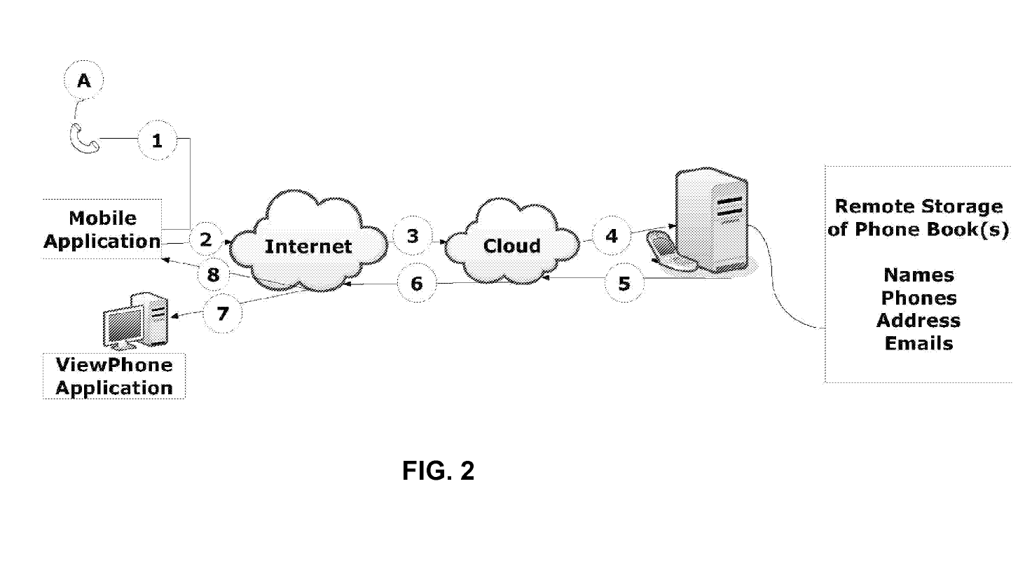

FIG. 2 is a schematic diagram of a system for providing a registration process for the viewphone applications, in accordance with various embodiments. In a public switched telephone network (PSTN) the telephone (A) and its telephone book are registered to a directory (e.g., remote storage of telephone books), using a mobile application. The mobile application recovers data in the telephone book from the telephone or its smartcard inside the telephone (SIM) or internal memory system 1. The mobile application sends the recovered data and data packets using the internet (arrow 2). The data packets are sent to the cloud (arrow 3) and then sent to a storage device on a server (arrow 4). When the data packets are received and properly stored, the server sends back a registration number (arrows 5, 6) that can be a globally unique identifier (GUID) representing the hash of the registered telephone to be stored in the mobile application and telephone registry (arrow 8), or stored in a personal computer (arrow 7). Once registration is performed, the mobile telephone number is linked to a mobile identification represented by GUID. This GUID may also be stored in a cookie to permit a cross-identification of the users and the devices used.

Registration may also be performed by the viewphone application (stored on the personal computer) by automatically pairing the mobile telephone using bluetooth when available, and thus recovering the telephone book using bluetooth, then when viewphone application has recovered all the desired information, the viewphone application can send this information using the Internet to the cloud and directory (for a remote storage)

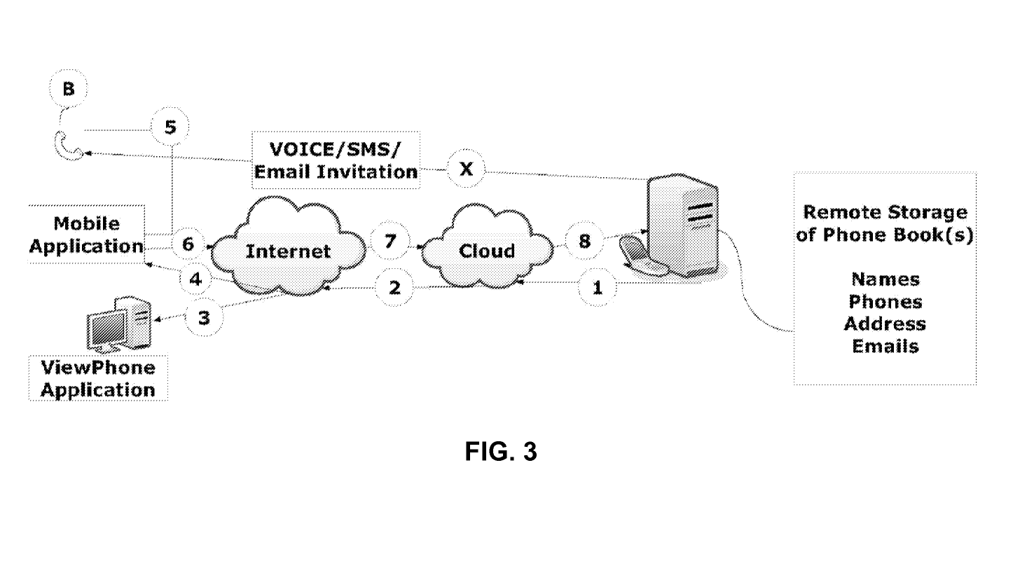

FIG. 3 is a schematic diagram of a system for providing an invitation process for the viewphone applications, in accordance with various embodiments. Upon reception of the telephone book of registered users, the servers in the cloud sends invitations (arrows 1, 2, 3) using automated voice calls, SMS, or emails (arrow X) to invite new users using, e.g., hyperlinked messages. Hyperlinked messages can also embed a Javascript to recover cookies information of the invited new users. Once the invited person acknowledges and validates the invitation, a mobile application is downloaded and installed on the invited person's personal computer. The mobile application may associate the invitation to a GUID, which is an identifier the link between the PSTN number and its mobile application. On the cloud the GUID links to the PSTN numbers, and serves as an index directory, linking the GUID to telephone numbers, as well as linking cross-domain cookies to an identified user's GUID.

The telephone (B) may also be paired with the personal computer. The viewphone application stored on the personal computer may recover the telephone book from the telephone using bluetooth (when the mobile telephone has bluetooth capability). In order to add the telephone (B) and its telephone book to the cloud and its remote storage, the telephone book may be associated to the GUID or a serial identification.

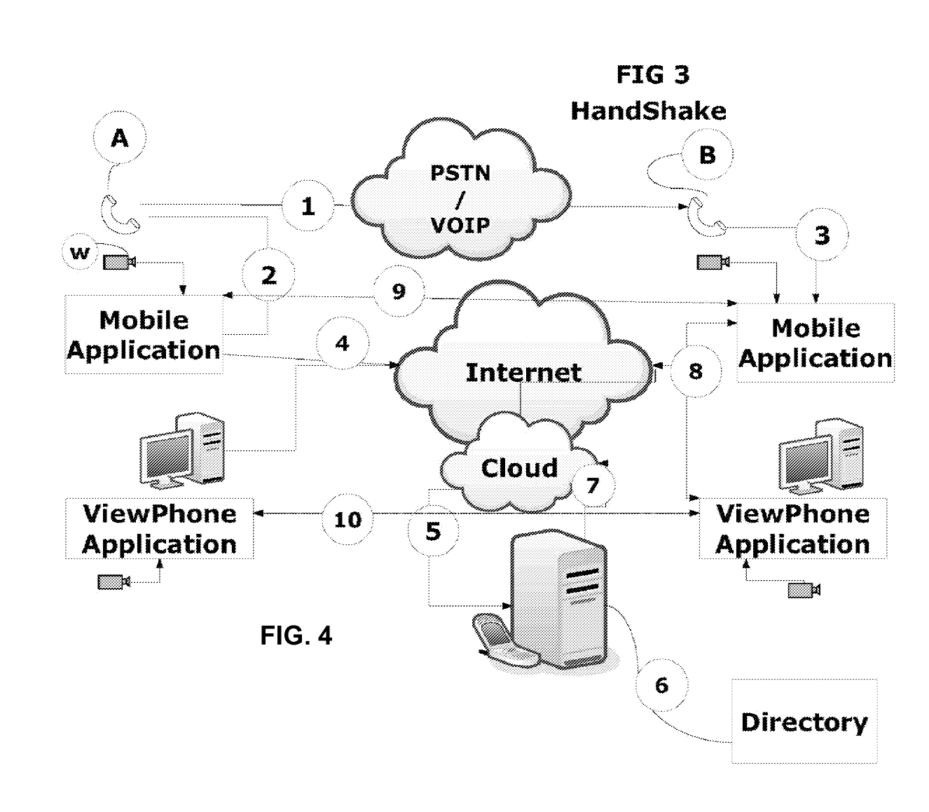

FIG. 4 is a schematic diagram of a system for providing a handshake process for the viewphone applications, in accordance with various embodiments. When a call is received at a telephone (A), the mobile application (i.e., viewphone application) of telephone (A) recovers using, e.g., bluetooth functionality, the telephone number that initiated the call (B), then sends this telephone number to the cloud's remote storage. The mobile application may check if the telephone number that initiated the call (B) is in the directory. If not, the server may send (arrow 6) an invitation with an hyperlink that includes a serial number for further authentication, as well as any cross-domain cookies information with a read-only script (e.g., Javascript to hypertext preprocessor (PHP) or PHP to Javascript).

If the telephone number is already registered, the mobile application of telephone (A) asks the telephone user (B) if he wants to join a videoconference. If telephone user (B) validates the invitation for a videoconference that is sent from the mobile application of telephone (A) to the mobile application of telephone (B) (arrow 9), the telephone user (A) acknowledges the videoconference, and the mobile application of telephone user (A) initiates the local webcam (W) and sends or streams the video to the mobile application of telephone (B). At the same time the mobile application of telephone (B) initiates its local webcam and sends or streams the video to the mobile application of telephone user (A). When the telephone conversation is finished, the streaming will stop on both ends.

In various embodiments, the telephone of each of telephone user (A) and telephone user (B) is paired with a personal computer, and the webcam of each of the personal computers can be used to send or stream video (two-way arrow 10). If a user decides to make a conference call using his telephone, the mobile application of the user may send invitations to everyone being invited, upon validation from the initiator of the call.

At anytime the users can switch from PSTN to VOIP, as well as stopping the video.

In various embodiments, when a user is in a video conference near a paired computer (using, e.g., bluetooth), the viewphone application on the paired computer may propose that the user switches the webcam from the mobile application to the paired computer so that the user can stream video using the paired computer for a better quality call experience.

In various embodiments, the user can have multiple computers, paired with one mobile device, or a plurality of mobile devices paired to one computer. Temporary pairing (e.g., just for one call) may also be used.

In the case of disparate codecs with different platforms, the video streaming can be rerouted to a server to perform the transcoding in the appropriate video format so that the receiver can receive in its own environment.

The codec may be sent dynamically to the receiver application (i.e., viewphone application) on the fly before the videoconference occurs. For example, the codec may be sent from Iphone to android, from h264 to vp8 and vice versa, and from vp8 to h264.

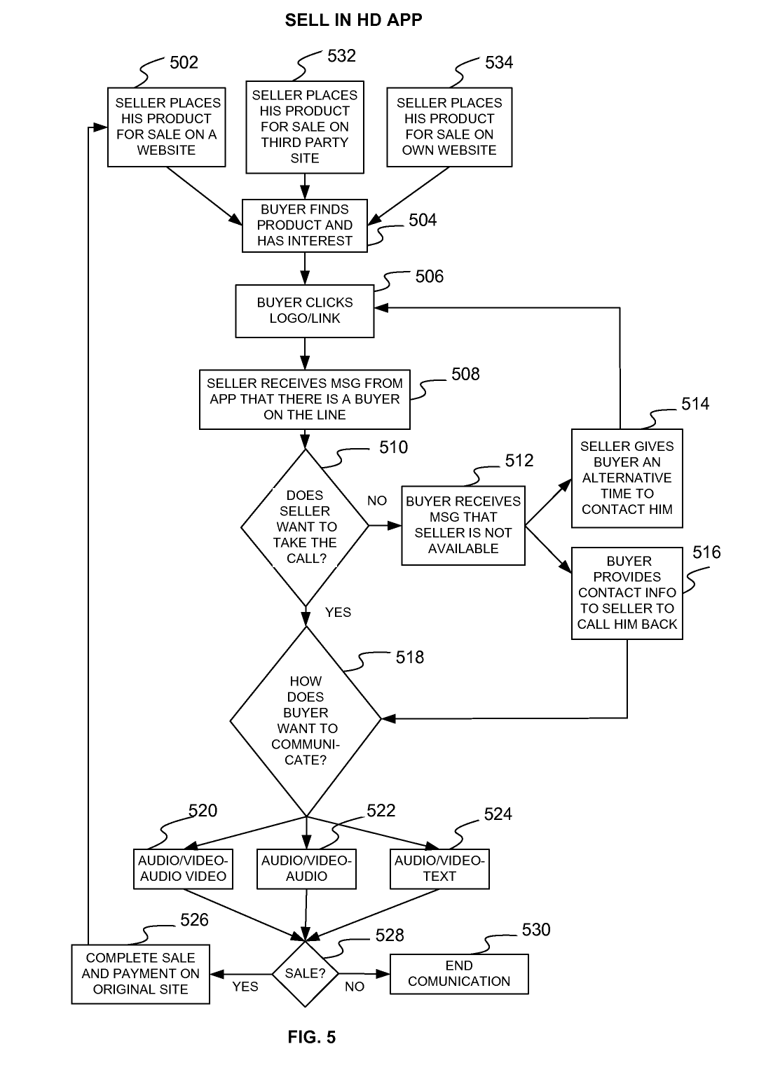

FIG. 5 is an exemplary flow chart illustrating a method for product sellers to market their products on the Internet using the viewphone applications, in accordance with various embodiments. The method provides a product seller the ability to market his products on the Internet, and allows the product seller to immediately communicate with a buyer using, e.g., audio and/or video, and allows the product seller to show his product using, e.g., live video to a buyer and simultaneously communicate to the buyer using, e.g., audio or chat. During that process, a script may read cross-domain cookies located on the buyer's computer and send that information for storage on the cloud.

In various embodiments, a seller places his product for sale on a website, such as sellinHD.com website (block 502). In various embodiments, the seller installs a viewphone application, such as sellinHD application, on his mobile device, such as iPhone or iPpad. In various embodiments, a buyer searches the seller's website, e.g., sellinHD.com, and finds the seller's product that he is interested in (block 504). The buyer clicks a link on the seller's website (block 506), which activates the viewphone application on the seller's mobile device. The viewphone application advises the seller on his computer and/or mobile device that he has a buyer interested in a specific product that the seller is selling (block 508). The viewphone application gives seller the option (1) to make immediate contact with the buyer (block 510) or (2) to advise the buyer that the seller is not currently available (block 512). If the seller chooses option (1), an immediate video conferencing link is made between the buyer and the seller per buyer's preference (block 518). This link may be a two-way voice and video (block 520). The hyperlink or link may also embed Javascript capabilities to recover read-only cross-domain cookie information for identification purposes. Alternatively, the link may be two-way voice only (not shown), two-way voice and one-way video (block 522), or one-way video with chat (block 524). For example, flash or equivalent technologies may be used to capture buyer's webcam or screen data. That feed, which represents a wrapped audio/video data, may be sent to the cloud, and then sent from the cloud to the seller. The buyer may also use local flash capture capabilities to capture buyer's webcam or screen data and send that data to the cloud so that the seller can see the buyer. The seller has the ability to show the product live to the buyer, communicate with the buyer, view the cross-domain cookies stored on the buyer's computer to identify searches on competitors or products, and sell the product to the buyer at the same time (blocks 528, 526). If the seller chooses option (2), the seller may send a message to the buyer (block 512) to either try him back at a certain time (block 514), or to leave the buyer's personal information so that the seller can call the buyer back (block 516).

In another embodiment, the seller posts his product on a third party website for sale (e.g. ebay, craigslist, realtor.com, B2B website) and includes the seller's logo link, such as “Sell-in-HD,” in his advertisement on the third party website (block 532). In various embodiments, a buyer interested in the seller's product (block 504) clicks the seller's logo link, such as “Sell-in-HD” (block 506). The viewphone application advises the seller on his computer and/or mobile device that he has a buyer interested in a specific product that the seller is selling (block 508). The viewphone application gives the seller the option (1) to make immediate contact with the buyer (block 510) or (2) to advise the buyer that the seller is not currently available (block 512). If the seller chooses option (1), an immediate video conferencing link is made between the buyer and the seller per buyer's preference (block 518). This link may be a two-way voice and video (block 520), two-way voice only (not shown), two-way voice and one-way video (block 522), or one-way video with chat (block 524). The seller has the ability to show the product live to the buyer, communicate with the buyer, and sell the product to the buyer at the same time (blocks 528, 526). If the seller chooses option (2), the seller may send a message to the buyer (block 512) to either try him back at a certain time (block 514), or to leave the buyer's personal information so that the seller can call the buyer back (block 516).

In yet another embodiment, a seller posts his product on his own website and includes the seller's logo link, such as “Sell-in-HD” on his website (block 534). The link may be placed generally on the website, on the contact page, or next to a specific product. In various embodiments, a buyer interested in the seller's product (block 504) clicks the seller's logo link, such as “Sell-in-HD” (block 506). The viewphone application advises the seller on his computer and/or mobile device that he has a buyer interested in a specific product that the seller is selling (block 508). The viewphone application gives the seller the option (1) to make immediate contact with the buyer (block 510) or (2) to advise the buyer that the seller is not currently available (block 512). If the seller chooses option (1), an immediate video conferencing link is made between the buyer and the seller per buy's preference (block 518). This link may be either two-way voice and video (block 520, two-way voice only (not shown), two-way voice and one-way video (block 522), or one-way video with chat (block 524). The seller has the ability to show the product live to the buyer, communicate with the buyer, and sell the product to the buyer at the same time (blocks 528, 526). If the seller chooses option (2), the seller may send a message to the buyer (block 512) to either try him back at a certain time (block 514), or to leave the buyer's personal information so that the seller can call the buyer back (block 516).

The hyperlink structure defines the level of implementation to permit the above described embodiments to be able to work accordingly, in accordance with various embodiments.

In various embodiments, the hyperlink is not a simple static hyperlink, but a mix of static hyperlink redirected to a dynamic hyperlink, and redirected to the registered user. Cookie interactions (e.g., read/write) may be read from a Javascript if a visitor (e.g., potential buyer) has already used the system or not used the system, as well as reading cross-domain cookies and storing that information on the cloud. This information may be set as accessible for the sellers or set as not depending on viewphone/Sell-in-HD policies. Otherwise, cookie will be created. The Javascript and/or server script combination may also gather the visitor's IP address, which may be a link to a database of geolocation. The dynamic link is a unique link for every visitor, dynamically created, encoded, and/or compressed on the fly based on the user's IP address. A receiver's (e.g., the registered user) IP address (dynamic IP or static IP) may also be encoded on the fly using a restful call to a cloud database of registered users to recover a serial number identifying the registered user.

In various embodiments, a third party server may receive the visitor and provide the link between the static hyperlink and dynamically created hyperlink to the registered user, to perform log analysis regarding how many people clicked on the link, and when and where the click occurred, including the history of the visitor before the click occurred, which includes cookies and cross-domain cookies.

In various embodiments, the seller may go to a third party website, register himself, and download a viewphone application used to keep track of the user using the Internet. The seller may then locally create on his own computer hyperlinks that link to products the seller wants to sell. The viewphone application may also be a web-based application that allows the seller to login to use the services of, e.g., hyperlink creation or a mix of application and/or web-based services.

In various embodiments, the seller services includes (but is not limited to): tracking users (i.e., visitors), identifying where the users come from, geolocation, products clicked, frequencies, and transaction history, such as past issues on products delivered, cancellations history, credit card issues.

In various embodiments, the seller can post the following encoded exemplary hyperlink: http://sellinginhd.com/rewrwerewregfhbgncxvcbvbvnbvnbvnbvnzcxzvcvcbvcbvc bcvbvcbbcbvcbvcbvvcbvcbvcbvbcbvvcbvbcbvcbvbcczxxgfdgdgdfgdfhytyryetthjh gjiyuiuiyuiiyiiuiyurgfdgfgdgdfggdgfggwarewrewwtw

An exemplary decoded version looks like the following:

http://sellinginhd.com/video=1:Audio=1:chat=1:sellerid=984573:product=1239543:tracking=1:allowvideoconference=1:dltime=08/24/2011-12:00:00:GMT=08/24/2011-5:00:00

When the decoded version of the hyperlink is received, the sellinHD.com may propose to a potential buyer to download the viewphone application, such as Sell-in-HD, which may include a video/audio/chat conferencing system or a Java application that runs directly on the potential buyer's browser.

When the viewphone application, such as Sell-in-HD, receives the request from a potential buyer, the viewphone application may create a dynamic link to the seller, such as http://sellerIP:seller port: buyerip:buyerport:product=“productname”:clktime=08/24/2011-5:00:00. This link may initiate the communication between the buyer and the seller using transmission control protocol/Internet protocol (TCP/IP) and/or user datagram protocol (UDP).

The sellinHD.com will then provide the link between the buyer and the seller by calling the seller on the seller's viewphone application, or using voice over Internet protocol (VOIP) or on the seller's mobile/pstn telephone. Existing video-conferencing application, such as Skype, oovoo, or Chat, may be used for the conference call. The seller's viewphone application, such as Sell-in-HD, may enable and/or disable the video-conferencing functions based on, for example, the seller's availability (e.g., can only be called from 9:00 eastern time to 18:00 everyday, Saturdays, Sundays and majors holidays excluded).

The seller can also broadcast his screen or broadcast recorded video (not only webcam) to show his customer during the call. For example, an insurance agent or lawyer may want to review documents, or a product seller may want to view a photo of an item in an online catalog.

### Systems and Methods of Exchanging Dynamic Information

As described above, there is a need to expand the exchange of dynamic information across electronic networks to a client/server configuration. Dynamic information includes, for example, streaming video and/or audio data. However, the high-bandwidth requirements for dynamic information impose a number of technological limitations that must be overcome in order to allow dynamic information to be available to social networks.

One exemplary real time protocol that was developed for exchanging audio and video data between a server and a client is the real time messaging protocol (RTMP), which was designed to permit low-latency persistent communication between a server and client. Other exemplary real time protocols include, include but are not limited to, encrypted RTMP (RTMPE), RTMP tunneled (RTMPT), real time media flow protocol (RTMFP), real time transport protocol (RTP), user datagram protocol (UDP), transmission control protocol (TCP), and HTTP.

In various embodiments, a real time messaging protocol, such as RTMP, RTMPE, RTMPT, RTMFP, RTP, UDP, TCP, HTTP, hypertext markup language (HTML) 5, or any other protocol, is used to allow dynamic information to be available to social networks. For example, two or more client devices, or broadcasters, can stream audio and video to each other through a server. In addition, known or unknown third parties can view the audio and video being streamed to and from the two or more client devices by viewing a webpage on the server that includes an embedded player for the real time messaging protocol.

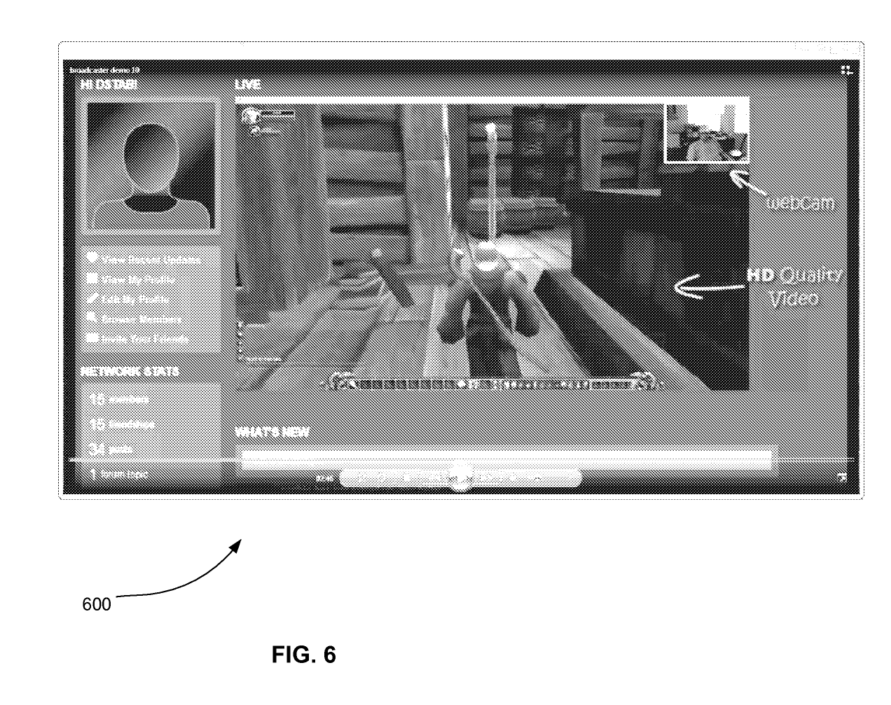

FIG. 6 is an exemplary webpage 600 of a first user showing the video broadcast by a first user, in accordance with various embodiments. Consider a group of three users playing an online game, for example. Each of the users has a webcam and microphone that can stream audio and video data to a server. The server allows a first user to create a webpage that can display audio and video from the first user and audio and video from the other two users simultaneously. The streaming audio and video can be from a webcam, a game, a movie video, or any other type of video. By placing audio and video from the webcams of the other users on the webpage, the first user can, for example, monitor the reactions of the other two users as the game is being played. As shown in FIG. 6, the first user can start the webpage by adding video from the first user's own webcam and game. The video is displayed on webpage 600 using a real time messaging player or through the use of a browser recognized protocol such as HTML 5 or HTML 5 video, for example.

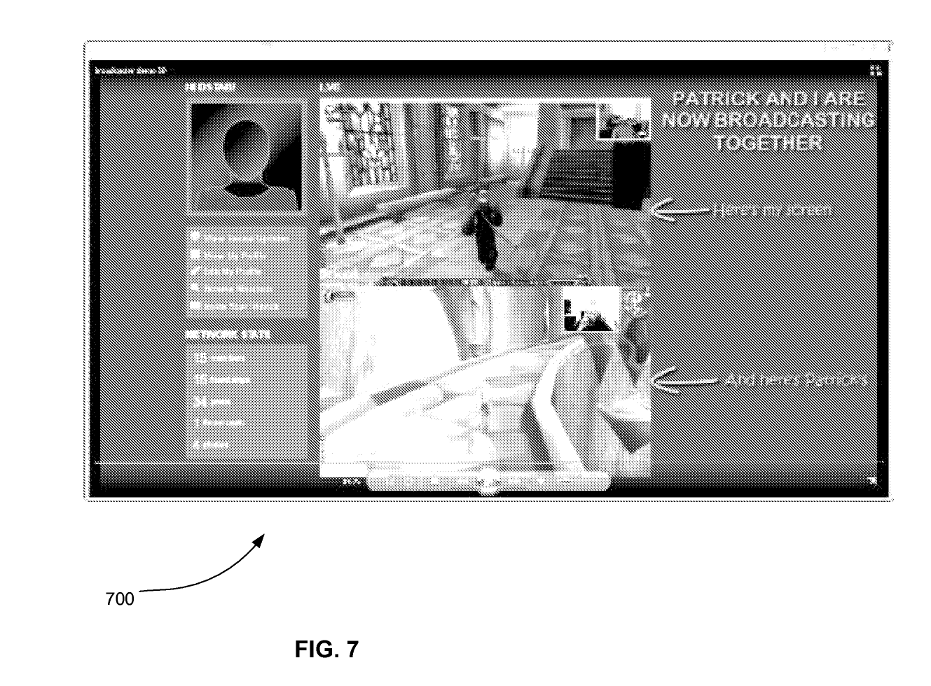

FIG. 7 is an exemplary webpage 700 of a first user showing the video broadcast by the first user and a second user, in accordance with various embodiments. A second user is also broadcasting video from the second user's own webcam and game. As shown in FIG. 7, the first user can add the broadcast of the second user to the webpage of the first user.

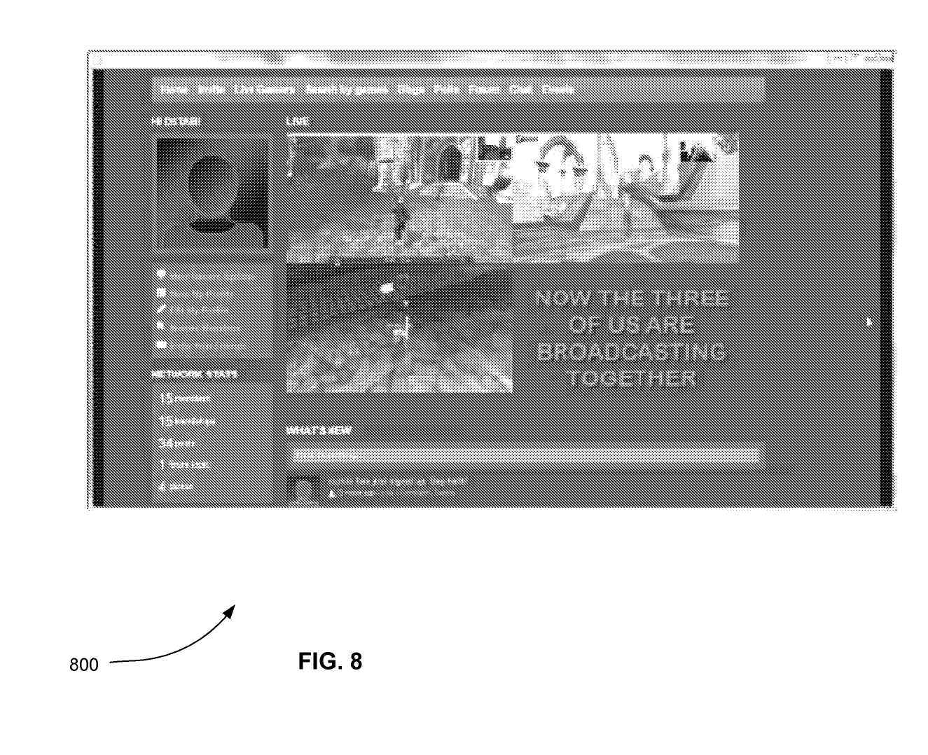

FIG. 8 is an exemplary webpage 800 of a first user showing the video broadcast by the first user, the second user, and a third user, in accordance with various embodiments. The third user is broadcasting video from the third user's own game only. As shown in FIG. 8, the webpage of the first user now includes broadcasts from all three users.

In addition, the first user can give access to their webpage showing the other two users, to the other two users, to one or more third parties, or to the general public. In other words, the first user can give access to their webpage to a social network. In this way, people other than the game players can monitor the activities of the players. The first user described above can give access to webpage 800 of FIG. 8 to a social network, for example.

In a client/server configuration, it is important that the streaming audio and video are secure. In other words, it is important that the dynamic information between a client and a server cannot easily be intercepted and manipulated. A number of enhancements have been developed to improve the security of RTMP. One enhancement is an RTMP session wrapped in a secure sockets layer (SSL) session, or RTMPS. Another enhancement is an RTMP session wrapped in an encryption layer, or RTMPE. Both enhancements, however, fall short of the necessary speed and/or for security needed for exchanging dynamic information between a client and a server in a social network.

In various embodiments, RTMP is enhanced to include an authentication token in the meta data of RTMP. Placing an authentication token in the meta data of RTMP allows a client device to be identified and to securely communicate with a server. Placing the authentication token in the meta data of RTMP allows the security of the system to be maintained without reducing the performance of the network connection significantly. One skilled in the art will appreciate that the token can be a key or code, and can be placed in a header or string name data of RTMP. The authentication can be implemented using, for example, challenge-response authentication, which is a family of protocols in which one party presents a question (i.e., challenge) and another party provides a valid answer (i.e., response) to be authenticated. The authentication can also be implemented using public key authentication or a combination of challenge-response authentication and public key authentication.

In various embodiments, RTMP is also enhanced to include functions for reordering the audio and video packets with timestamps to reduce latency. The RTMP client includes an application for time stamping audio and video packets, for example. The RTMP server then includes an application that reorders the audio and video. The RTMP server receives the each audio packet, determines the time stamp of the audio packet, and places the video packet or packets with corresponding time stamps next to the audio packet.

When a client sends the video and the audio to the server, the server uses the audio timestamping to synchronize the video and wrap them together to be sent to the viewers. A typical video frame rate is 10 to 30 fps (frames per second), for example. A typical audio rate, in comparison, is 44,100 Hz, or 44,100 cycles per second, for example. By using the timestamping of the higher rate audio first and applying it to the lower rate video, the video is made to be in synchronization with the audio.

Exemplary webpage 800 is described above with respect to RTMP for illustration purposes only. One skilled in the art will appreciate that other types of real time messaging protocols can equally be used.

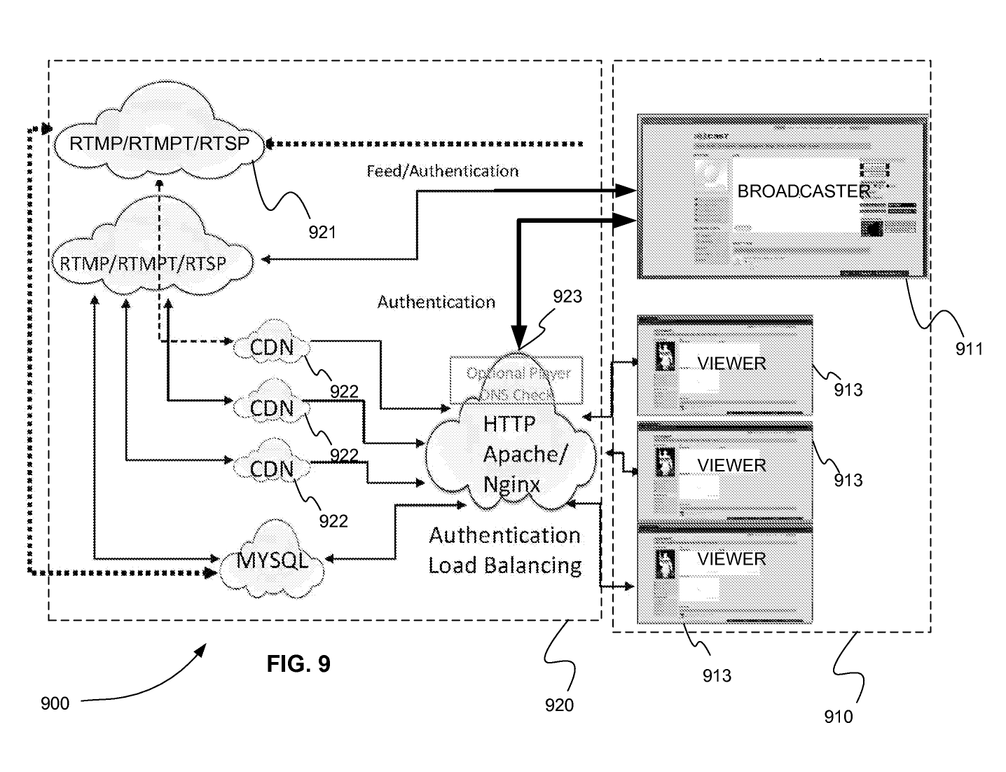

FIG. 9 is a schematic diagram of a system 900 for video and audio sharing across a network, in accordance with various embodiments. System 900 includes one or more client devices 910 and one or more servers 920. A server can include a computer system, such as the computer system show in FIG. 1. A client can include, but is not limited to, a computer system, a smart phone, a game player, a music player, a tablet computer, or a personal digital assistant.

A server 921 receives a request to broadcast video and/or audio from a broadcasting client device 911. The request is sent using RTMP, RTMPE, RTMPT, RTMFP, RTP, UDP, TCP, or HTTP, for example. One skilled in the art will appreciate that other types of real time messaging protocols can equally be used. Embedded in the meta data, header, or string name data of the request is an encrypted token, key, or code that was encrypted by client device 911. Server 921 reads the meta data of the request and decrypts the encrypted token and authenticates the request based on the decryption. The token can be encrypted and authenticated using public-key infrastructure (PKI), for example. The token can also use salt cryptography to change the bits of encrypted token with each transmission, for example. One skilled in the art will appreciate that other challenge-response protocols can equally be used.

Every transmission of streaming video and/or audio data from client device 911 to server 921 after the request also includes the encrypted token. In this way, the security of communication between client device 911 and server 921 is maintained.

For each streaming audio and video transmission, server 921 also reorders the audio and video packets, if necessary. Server 921 ensures that the audio and video packets recorded at the same time are grouped together for lip-synching, viewing, and hearing at the same time. In order to reorder the audio and video packets, server 921 inspects the time stamps of the audio and video packets.

Server 921 is one of many servers that can be used. In order to handle many users with many broadcasting client devices, servers 920 can include many servers, such as server 921. Servers 920 are further load balanced to improve performance. Servers 920 can include content delivery networks (CDN) 922, cloud systems, and hypertext transfer protocol (HTTP) servers 923, for example.

In a multiple server configuration, for example, HTTP server 923 serves webpages that include streaming video and/or audio to client devices 913. Client devices 913 can be the devices of users who are also broadcasting, or they can be users of a social network that are viewing the webpages and broadcast of others. The viewing of webpages and broadcasts can optionally include a domain name system (DNS) check to provide a level of security by checking if the viewer has the right to view or not from its domain name. HTTP server 923 also can provide load balancing.

In various embodiments, virtual machines (VMs) associated with a graphics processing unit (GPU) cloud may be added to current server implementations in order to run games, applications, or any content. In various embodiments, the audio/video signal of each game, application, or content is redirected using dedicated and channeled virtual display device drivers and/or virtual audio drivers that send the audio/video signal directly to the RTMP, RTMPS, RTMPE, RTMPT, RTMFP, RTP, UDP, TCP, or HTTP servers for broadcast and that receive back from the users, channeled control, keyboard, mouse, or joystick data signals in order to remotely use the software resource on the VMs. The audio/video latency may be optimized to allow a real cloud interactive remote solution. In addition, in order to optimize network latency, the RTMP, RTMPS, RTMPE, RTMPT, RTMFP, RTP, UDP, TCP, or HTTP servers may also be hosted inside the same VMs. In this embodiment, the user may optionally upload his or her game and/or the title and/or serial number that identify a game to the VMs, allowing the user to play his or game with his or her friends on the cloud using his or her computer and/or mobile device. One skilled in the art will appreciate that other methods of identifying a game can equality be used.

In an embodiment, the system provides financial retribution for the owner (i.e., user) of the game on a per play basis, for example. For example, the game may be paused for the players and video advertising may be inserted at timed intervals.

In various embodiments, aspects of social networking sites are combined with live broadcasting sites. When a user signs up to become a member, the member receives his or her own home page and channel so that he or she can conduct live broadcasts. In various embodiments, the page or channel is “owned” by a member, and the member controls who may broadcast on his or her home page.

In various embodiments, a member can make “friends” with other members on the website. By making friends, a broadcaster may add one of the broadcaster's friends to the broadcaster's home page. When a friend is added to a home page, an additional screen may be added to the home page to include the friend's channel.

The size of the screens may be reduced depending on how many friends' channels are added to the home page, in order to fit all the screens on the home page. The number of friends/channels that may be added to the home page may be limited only by the size of the screen and the ability to reduce the size of the screen.

In various embodiments, a player's channel may be embedded into other players' channels on other websites, so that the player's broadcast may be seen simultaneously on other websites.

In various embodiments, the system automatically broadcasts players that are playing together in a clan or team by intercepting a game console's network feed, or have players play together through a website.

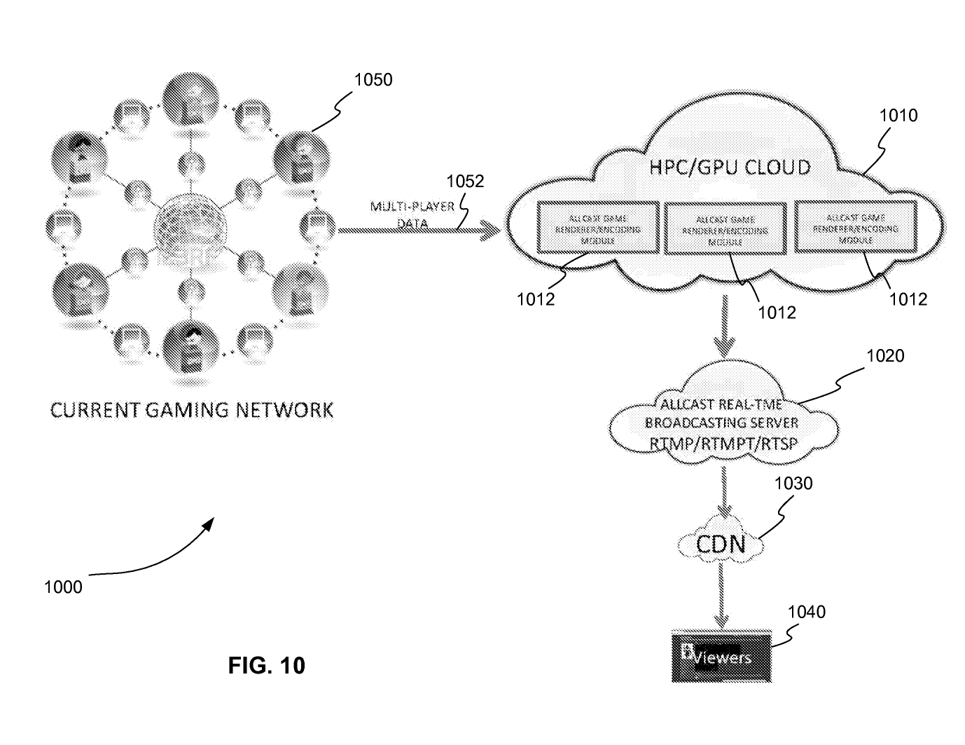

FIG. 10 is a schematic diagram of a system 1000 for video and audio sharing across a network that uses direct server broadcasting, in accordance with various embodiments.

In various embodiments, system 1000 can tap into a gaming network 1050 and render any game being played on the network 1050 on high performance GPU servers (that include game rendering/encoding modules 1012) in a high performance computer (HPC)/GPU cloud 1010. One skilled in the art will appreciate that other types of networks can equally be used.

In various embodiments, system 1000 sends the rendered game to a real-time broadcasting server 1020, using RTMP, RTMPE, RTMPT, RTMFP, RTP, UDP, TCP, or HTTP, for example. One skilled in the art will appreciate that other types of real time messaging protocols can equally be used.

In various embodiments, real-time broadcasting server 1020 sends streaming video and/or audio of the rendered game to content delivery networks (CDN) 1030. The rendered game is broadcasted in real time to viewers 1040 on client devices.

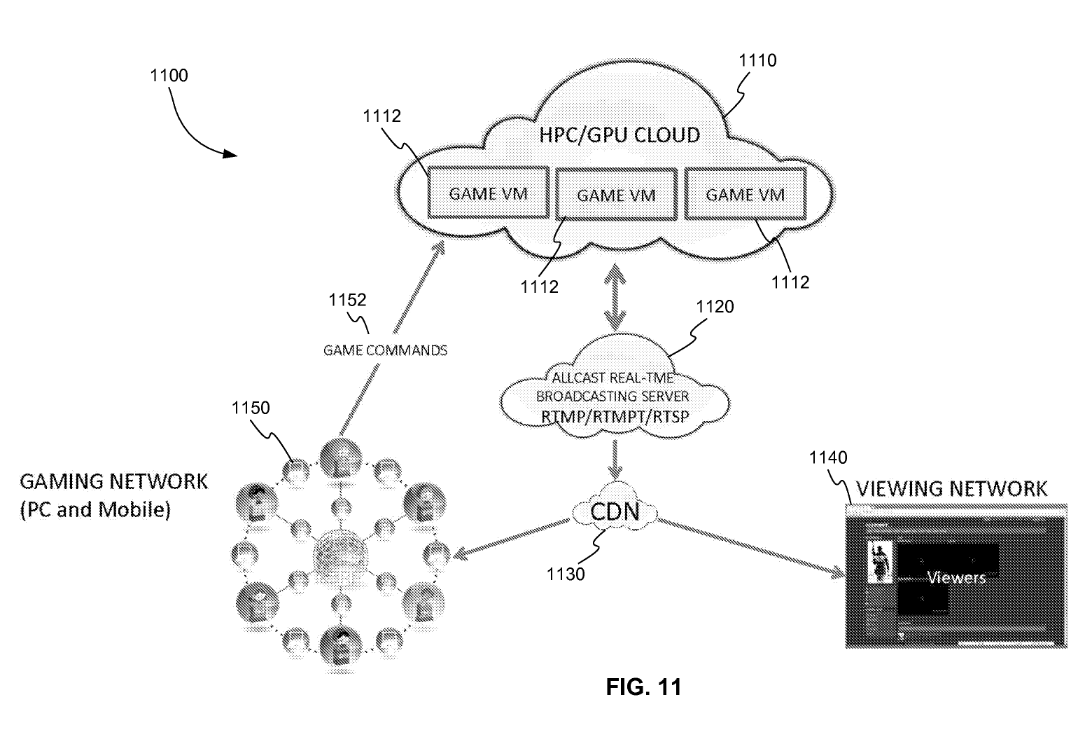

FIG. 11 is a schematic diagram of a system 1100 for video and audio sharing across a network that allows full cloud gaming, in accordance with various embodiments.

In various embodiments, system 1100 allows games to be played and rendered directly on game VMs 1112 in a HPC/GPC cloud 1100. One skilled in the art will appreciate that other types of networks can equally be used.

In various embodiments, system 1000 sends the rendered game to a real-time broadcasting server 1120, using RTMP, RTMPE, RTMPT, RTMFP, RTP, UDP, TCP, or HTTP, for example. One skilled in the art will appreciate that other types of real time messaging protocols can equally be used.

In various embodiments, real-time broadcasting server 1120 sends streaming video and/or audio of the rendered game to content delivery networks (CDN) 1130. The rendered game is sent either to players on computers and/or mobile devices in a gaming network 1150 or to viewers 1140 on client devices. In various embodiments, game commands 1152 are sent back using, for example, RTMP or any other protocol including UDP, from the players in gaming network 1150 to the games running on game VMs 1112 in HPC/GPC cloud 1100.

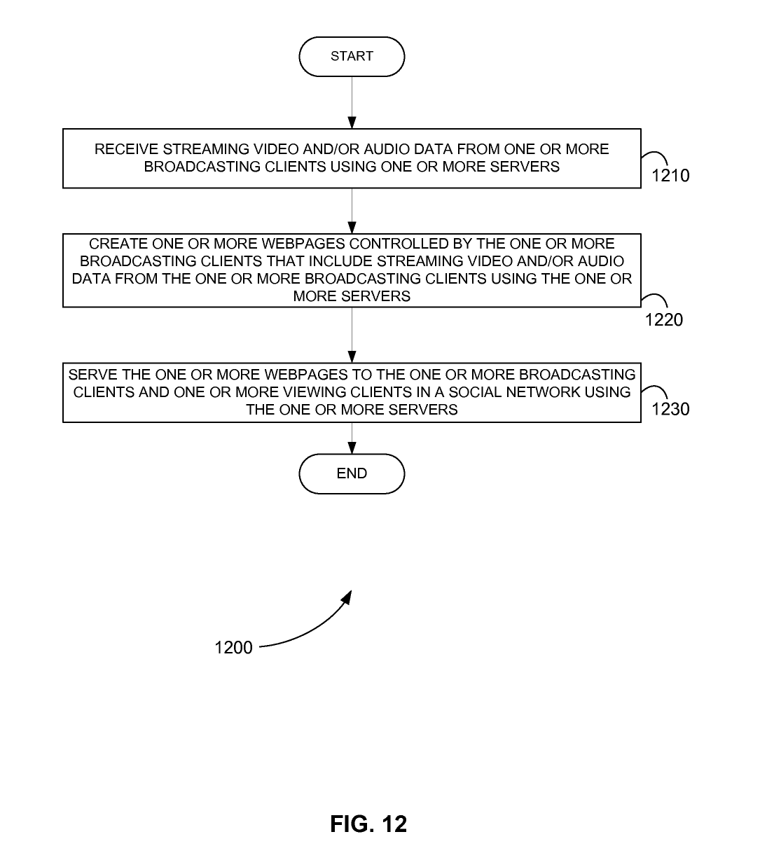

FIG. 12 is a flowchart showing a method 1200 for sharing streaming audio and video data in a social network, in accordance with various embodiments.

In step 1210 of method 1200, streaming video and/or audio data is received from one or more broadcasting clients using one or more servers.

In step 1220, one or more webpages controlled by the one or more broadcasting clients are created that include streaming video and/or audio data from the one or more broadcasting clients using the one or more servers.

In step 1230 the one or more webpages are served to the one or more broadcasting clients and one or more viewing clients in a social network using the one or more servers.

In various embodiments, a computer program product includes a tangible computer-readable storage medium whose contents include a program with instructions being executed on a processor so as to perform a method for sharing streaming audio and video data in a social network. This method is performed by a system of distinct software modules.

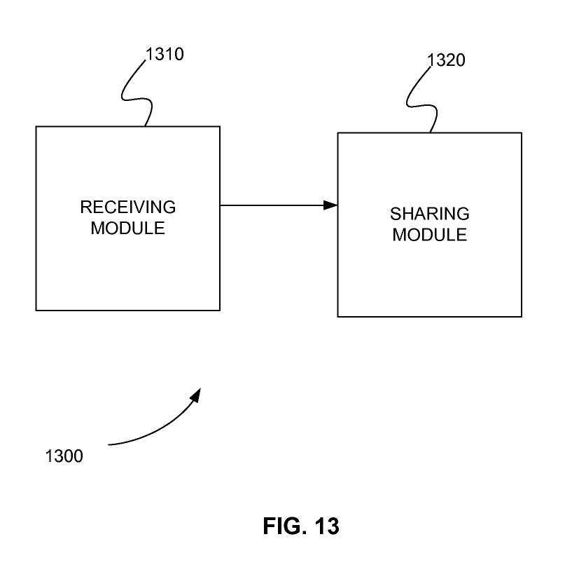

FIG. 13 is a schematic diagram of a system 1300 of distinct software modules that performs a method for sharing streaming audio and video data in a social network, in accordance with various embodiments. System 1300 includes a receiving module 1310 and a sharing module 1320.

Receiving module 1310 receives streaming video and/or audio data from one or more broadcasting clients. Sharing module 1320 creates one or more webpages controlled by the one or more broadcasting clients that include streaming video and/or audio data from the one or more broadcasting clients. Sharing module 1320 then serves the one or more webpages to the one or more broadcasting clients and one or more viewing clients in a social network.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. A system for sharing streaming audio and video data in a social network, comprising:
one or more servers that
receive streaming video and/or audio data from one or more broadcasting clients;
create one or more webpages controlled by the one or more broadcasting clients that include streaming video and/or audio data from the one or more broadcasting clients; and
serve the one or more webpages to the one or more broadcasting clients and one or more viewing clients in a social network on a website.

2. The system of claim 1, wherein one or more servers receive the streaming video and/or audio data using a real time protocol and authenticate the streaming video and/or audio data by decrypting and authenticating an encrypted token in the meta data of the real time protocol.

3. The system of claim 2, wherein the real time protocol is a real time messaging protocol (RTMP) that permits low-latency persistent communication between a server and a client.

4. The system of claim 1, wherein one or more servers further reorder the received streaming video and audio data by examining time stamps of video and audio packets and grouping video and audio packets that were recorded at substantially the same time.

5. The system of claim 1, wherein the streaming video and/or audio data is obtained from one or more of a webcam, a game, and a movie video.

6. The system of claim 1, wherein the one or more viewing clients are users of a social network that are viewing webpages and broadcast of others, and wherein the one or more servers provide a domain name system (DNS) check to provide a level of security.

7. The system of claim 1, wherein the one or more servers use virtual machines (VMs) associated with a graphics processing unit (GPU) cloud to run games, applications, or any content.

8. The system of claim 1, wherein the streaming video and/or audio data is captured using an imaging device of a cellphone or smartphone.

9. The system of claim 1, wherein the imaging device is a low-cost camera, and wherein participants in a conference can check the availability of others when a scheduling a conference by viewing the streaming video and/or audio data captured by the low-cost camera.

10. The system of claim 1, wherein the one or more servers allow product sellers to market their products on the Internet using the streaming audio and/or video data.

11. The system of claim 1, wherein the one or more servers allow product sellers to immediately communicate with a buyer using the streaming audio and/or video data.

12. The system of claim 1, wherein the one or more servers enable broadcasting of games that are being played on a third-party multi-player gaming network through a cloud.

13. The system of claim 1, wherein the system enables full cloud gaming.

14. A method for sharing streaming audio and video data in a social network, comprising:
receiving streaming video and/or audio data from one or more broadcasting clients using one or more servers;
creating one or more webpages controlled by the one or more broadcasting clients that include streaming video and/or audio data from the one or more broadcasting clients using the one or more servers; and
serving the one or more webpages to the one or more broadcasting clients and one or more viewing clients in a social network using the one or more servers.

15. A computer program product, comprising a non-transitory computer-readable storage medium whose contents include a program with instructions being executed on a processor so as to perform a method for sharing streaming audio and video data in a social network, the method comprising:
providing a system comprising distinct software modules that comprise a receiving module and a sharing module;
receiving streaming video and/or audio data from one or more broadcasting clients using the receiving module;
creating one or more webpages controlled by the one or more broadcasting clients that include streaming video and/or audio data from the one or more broadcasting clients using the sharing module; and
serving the one or more webpages to the one or more broadcasting clients and one or more viewing clients in a social network using the sharing module.
